(19) United States
(12) Patent Application Publication
(10) Pub. No.: US 2017/0331913 A1
(43) Pub. Date: Nov. 16, 2017

(54) CONTENT BASED CONTENT DELIVERY NETWORK PURGING

(71) Applicant: Fastly, Inc., San Francisco, CA (US)

(72) Inventor: Devon H. O'Dell, Rodeo, CA (US)

(21) Appl. No.: 15/428,713

(22) Filed: Feb. 9, 2017

Related U.S. Application Data
(60) Provisional application No. 62/334,520, filed on May 11, 2016.

(51) Int. Cl. H04L 29/08; H04L 29/06

(52) U.S. Cl. CPC H04L 67/2842; H04L 67/34; H04L 67/10; H04L 67/42

(57) ABSTRACT

Disclosed herein are enhancements for operating a content delivery network to purge data objects from cache nodes of the content delivery network. In one implementation, a method of operating a cache node includes receiving purge messages and, for each message, identifying data objects to be purged based on a purge rule in each purge message, wherein the purge rule comprises at least one content attribute related to content in the identified data objects. The method further provides, purging the identified data objects.

### RELATED APPLICATIONS

This application hereby claims the benefit of and priority to U.S. Provisional Patent Application 62/334,520, titled “CONTENT BASED CONTENT DELIVERY NETWORK PURGING,” filed May 11, 2016, and which is hereby incorporated by reference in its entirety.

### TECHNICAL BACKGROUND

Network-provided content, such as Internet web pages or media content such as video, pictures, music, and the like, are typically served to end users via networked computer systems. End user requests for the network content are processed and the content is responsively provided over various network links. These networked computer systems can include origin hosting servers which originally host network content of content creators or originators, such as web servers for hosting a news website. However, these computer systems of individual content creators can become overloaded and slow due to frequent requests of content by end users.

Content delivery systems have been developed which add a layer of caching between the origin servers of the content providers and the end users. The content delivery systems typically have one or more cache nodes distributed across a large geographic region to provide faster and lower latency access to the content for the end users. When end users request content, such as a web page, which is handled through a cache node, the cache node is configured to respond to the end user requests instead of the origin servers. In this manner, a cache node can act as a proxy for the origin servers.

Content of the origin servers can be cached into the cache nodes, and can be requested via the cache nodes from the origin servers of the content originators when the content has not yet been cached. Cache nodes usually cache only a portion of the original source content rather than caching all content or data associated with an original content source. The cache nodes can thus maintain only recently accessed and most popular content as cached from the original content sources. Thus, cache nodes exchange data with the original content sources when new or un-cached information is requested by the end users or if something has changed in the original content source data.

In some implementations, it may become necessary to purge or remove content that is cached by the nodes of the content delivery network. These purges may come when content becomes out of date, when undesirable information is included in the content, or for any other similar purpose. However, maintaining synchronization of these purge requirements across the content delivery network can be difficult, as purge requests may be received at different times by each of the cache nodes in the network.

### Overview

Examples disclosed herein provide enhancements for operating a content delivery network to purge data objects from cache nodes of the content delivery network. In one implementation, a method of operating a cache node of the content delivery network includes, caching data objects in the cache node on behalf of at least one origin server, and receiving a set of purge messages, wherein each purge message in the set of purge messages comprises a rule that specifies at least one content attribute to be purged from the cache node. The method further provides, applying the rule to the data objects to identify which subset of the data objects have the content attribute specified in the rule, and purging the subset of the data objects from the cache node.

In some implementations, the method further includes, caching the rules from the set of purge messages and responding to end user object requests based on the cached rules.

### BRIEF DESCRIPTION OF THE DRAWINGS

The following description and associated figures teach the best mode of the invention. For the purpose of teaching inventive principles, some conventional aspects of the best mode can be simplified or omitted. The following claims specify the scope of the invention. Note that some aspects of the best mode cannot fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a communication system to purge data objects from a content delivery network according to one implementation.

FIG. 2 illustrates an overview of a cache node in a content delivery network according to one implementation.

FIG. 3 illustrates a method of operating a content delivery network to purge data objects according to one implementation.

FIG. 4 illustrates an operational scenario of purging data objects from a cache node of a content delivery network according to one implementation.

FIG. 5 illustrates an operational scenario of providing a data object to an end user device according to one implementation.

FIGS. 6A-6C illustrate a method of operating a content delivery network to respond to an end user device request according to one implementation.

FIG. 7 illustrates a cache node computing system according to one implementation.

### DESCRIPTION

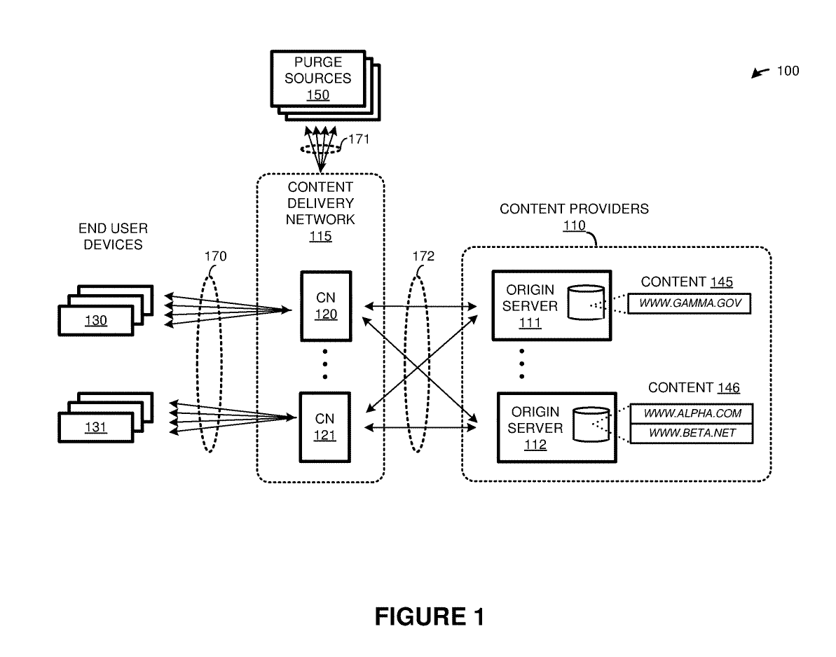

Network content, such as web page content, typically includes data objects such as text files, hypertext markup language (HTML) pages, pictures, video, audio, code, scripts, or other content viewable or downloadable by an end user in a browser or other application. This various network content can be stored and served by origin servers and equipment. The network content includes example website content referenced in FIG. 1, such as “www.gamma.gov,” “www.alpha.com,” and “www.beta.net,” but may include various other content. In some examples, origin servers can serve the content to end user devices. However, when a content delivery system is employed, the content delivery system can act as a proxy to cache content between origin servers and the end user devices.

Content delivery systems can add a layer of caching between origin servers of the content providers and the end users. The content delivery systems typically have one or more cache nodes distributed across a large geographic region to provide faster and lower latency local access to the content for the end users. When end users request content, such as a web page, a locally proximate cache node will respond to the content request instead of the associated origin server. Various techniques can be employed to ensure the cache node responds to content requests instead of the origin servers, such as associating web content of the origin servers with network addresses of the cache nodes instead of network addresses of the origin servers using domain name system (DNS) registration and lookup procedures.

In some implementations, content management systems, end users, or other entities or systems may desire to delete, purge, or change the content stored in the cache nodes. These changes and purges are desired to be propagated quickly and coherently throughout the content delivery system which includes many cache nodes. To implement desired changes, the included systems and methods provide for using content based purge rules to purge content from the network. These purge rules, transferred in purge messages from a purge source, include content attributes that describe content of specific data objects to be purged. These content attributes may include titles for specific data objects, text content for specific data objects, author information for specific data objects, subject or category information for specific objects, or any other similar content attribute. For example, if a content provider sought to remove all articles generated by a particular author, the content attribute for the purge rule may include the author name to delete the corresponding articles on the cache node. Once received, a cache node will identify any data objects associated with the content attribute and delete identified data objects. Further, in some implementations, the cache node may cache the cache rule to prevent future data objects from being cached and/or provided to end users that would violate the cache rule.

Referring now to FIG. 1, FIG. 1 illustrates a communication system 100 to purge content from a content delivery network according to one implementation. Communication system 100 includes end user devices 130-131, content nodes (CNs) 120-121, and origin servers 111-112. CNs 120-121 make up content delivery network 115, which caches content from content provider servers 110, including origin servers 111-112. End user devices 130-131 communicate with CNs 120-121 via communication links 170. CNs 120-121 communicate with origin servers 111-112 via communication link 172. Purge sources 150 communicate with CNs 120-121 via communication link 171.

To further illustrate FIG. 1, a brief description of the operation of communication system 100 is provided. In operation, end user devices 130-131 request network content, such as content 145-146, from CNs 120-121 in content delivery network 115. In particular, rather than being directed to origin servers 111-112, CNs 120-121 act as proxy servers that cache content in local storage systems from origin servers 111-112 and provide the content, if available, to the requesting end user devices. This content is divided on each of CNs 120-121 into data objects, which include, but are not limited to, text files, HTML pages, pictures, video, audio, code, scripts, or other content viewable or downloadable by an end user device in a browser or other application.

In some implementations, it may be necessary to purge or erase at least a portion of the content that is cached by CNs 120-121, wherein the purges may come when one or more data objects are out of date, include undesirable information, or for any other purpose. In particular, purge sources 150, which may comprise management consoles, end user devices, or some other purge source capable of removing content from content delivery network may generate a purge message with a purge rule and transfer the purge message to content delivery network 115. In response to receiving a purge message, a CN in CNs 120-121 may identify any data objects that are locally stored on the CN that apply to the purge rule, and erase the identified data objects. Further, in some implementations, each CN in CNs 120-121 may cache the purge rule from the purge message to prevent future data objects from being cached that violate the rule, and/or prevent future data objects from being provided to end user devices 130-131.

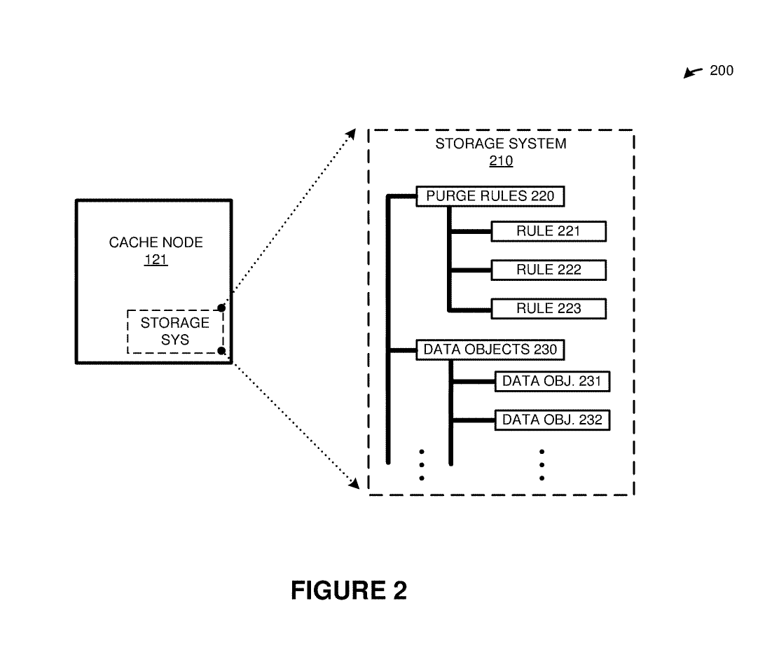

To further demonstrate the storage configurations of CNs 120-121, FIG. 2 is provided. FIG. 2 illustrates an overview 200 of a cache node in a content delivery network according to one implementation. FIG. 2 includes cache node 121 from FIG. 1 with local storage system 210 for storing purge rules 220 and data objects 230. Purge rules 220 include rules 221-223, which are representative of rules to purge data objects from storage system 210 on cache node 121. Data objects 230 includes data objects 231-232, which are representative of data objects, such as text files, HTML pages, videos, images, and the like.

As described previously in FIG. 1, cache nodes, such as cache node 121, cache data objects between end user devices and one or more origin servers. During the operation of the cache nodes, the cache nodes receive purge messages from purge sources, such as management consoles, end user devices, origin servers, or any other similar purge source. Once received, data objects associated with the purge message are identified and purged, preventing the identified objects from being provided for future content requests.

Here, in addition to purging the content associated with the purge messages, cache node 121 further caches the purge rules included in the purge messages. These rules may be cached in random access memory (RAM) for cache node 121, in some examples, but may also be cached in solid state storage or a hard disk drive local to cache node 120. By caching the purge rules received from the purge sources, cache node 121 may use the rules to prevent future caching of unwanted data objects, and may further prevent unwanted data objects from being provided to end user devices. For example, if a data object is received from a second node, cache node 121 may check rules 221-223 to determine if a rule exists for the data object. If no rule exists, then the object may be cached and/or provided to a requesting end user device. In contrast, if a rule does exist for the data object, cache node 121 may prevent the data object from being cached and/or provided to a requesting end user device.

In some implementations, in addition to the cache rules, the purge messages may further indicate a time to live (TTL) associated with the cache rules. This time to live may indicate minutes, hours, days, or any other similar time period for which a rule included in the message is valid. For example, a purge message for rule 221 may include a time to live of twenty-four hours. Once the twenty-four hours expires, the rule may be removed from purge rules 220 in storage system 210. This would allow data objects that otherwise violate the rule to be cached and/or provided to a requesting end user device.

Although illustrated in the example of FIG. 2 as a tree data structure, it should be understood that purge rules 220 and data objects 230 may be stored in any file system format capable of identifying rules and data objects for end user requests and incoming data objects.

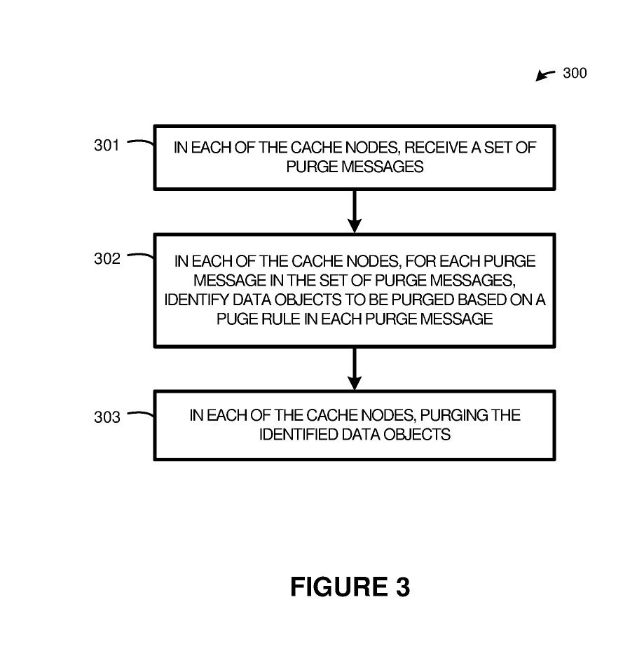

FIG. 3 illustrates a method 300 of operating a content delivery network to purge data objects according to one implementation. The operations of FIG. 2 are referenced parenthetically in the paragraphs that follow, along with references to the elements and systems from communication system 100 of FIG. 1.

In operation, purge sources 150 generate purge messages that are transferred to CNs 120-121 to purge data objects cached by CNs 120-121. Each CN of CNs 120-121 receive a set of purge messages from the purge sources (301) and, for each purge message in the set of purge messages, identify data objects to be purged based on a purge rule in each purge message (302). These purge rules indicate at least one content attribute describing data objects to be purged, wherein the at least one content attribute may comprise a title, an author, text content, or any other similar content attribute for the identified data objects. For example, a purge rule may direct all data objects with a particular title to be purged from the cache nodes. Accordingly, when the rule is received by one of CNs 120-121 the CN may identify any data objects cached locally by the CN that are related to the content attribute. Once the data objects are identified for each of the rules on a CN, the data objects are purged by the CN to prevent the objects from being provided in response to future content requests (303).

In some examples, in addition to purging data objects locally cached in response to purge messages, the purge rules in the purge messages may also be cached in the storage system of the receiving CN. These purge rules are then applied by the CN in preventing future data objects from being cached and/or provided to end user devices. For example, if CN 121 were to receive a content request from an end user device in end user devices 131, CN 121 would determine if a data object were available to support the requests. Once it is determined that a data object is not available for the request, CN 121 may request a second node, either another cache node or an origin server in origin servers 111-112, for the appropriate content. In response to the request, the second node may provide the required data object to CN 121, permitting the data object to be compared to purge rules cached on CN 121. If a purge rule applies to the received data object, CN 121 may prevent the data object from being provided to the end user device and may further prevent the data object from being cached on CN 121. However, if a purge rule does not apply to the received data object, then CN 121 may provide the data object to the end user device, and may further cache the data object in the storage system for CN 121.

In some implementations, rather than receiving an object from the second node, CN 121 may receive an indication that the object has been purged. For example, if CN 121 requested an object from CN 120, CN 120 may determine that a purge message had been delivered to purge the desired object, and respond to CN 121, accordingly. In such examples, CN 121 may respond to the end user device based on the indication supplied by the second node. This response may indicate that an error was found when attempting to retrieve the data object or may provide no data back to the end user device related to the requested data object. Further, because a purge indication is included in the response from the second node, CN 121 may prevent any object from being cached for the user request.

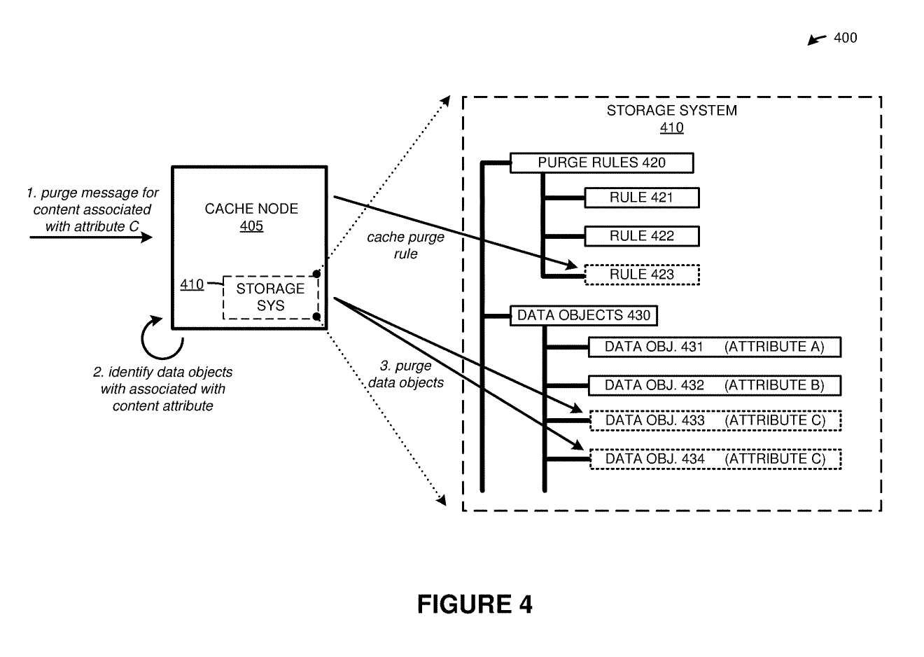

FIG. 4 illustrates an operational scenario 400 of purging data objects from a cache node of a content delivery network according to one implementation. Operational scenario 400 includes cache node 405 with storage system 410. Storage system 410 further stores purge rules 420 with rules 421-423 and data objects 430 with data objects 431-434. Cache node 405 is representative of a cache node similar to CNs 120-121 in FIG. 1.

In operation, cache node 405 receives, at step 1, a purge message for content associated with attribute C. This attribute may comprise a title associated with one or more data objects, an author associated with one or more data objects, a subject matter associated with one or more objects, text content in the one or more objects, or any other similar attribute associated with the content of the one or more objects. For example, attribute C may comprise an author associated with specific data objects, wherein the author may be a person, a company, a division of an organization, or some other content creator.

Once the purge message is received by cache node 405, cache node 405 identifies the purge rule within the purge message and identifies, at step 2, data objects associated with the purge rules. Here, because the purge rule from the purge message indicates a request to purge objects associated with attribute C, cache node 405 identifies data objects 433 and 434 to be purged. In contrast, objects 431 and 432 are not identified for the purge as the content of the data object does not coincide with the received request.

After identifying cached data objects local to cache node 405 that apply to the purge message, cache node 405 purges the identified data objects from storage system 410. This purging of the data objects prevents the data objects from being served in future requests to cache node 405. Further, as illustrated in the example of operational scenario 400, cache node 405 caches the new purge rule 423 from the purge message in purge rules 420. This allows cache node 405 to, when a data object is received from a second node, determine whether the object should be cached and/or provided to an end user device. For example, if cache node 405 did not possess a required data object for a content request, cache node 405 may request the data object from a second node. Once the data object is received from the second node, cache node 405 may determine if the data object violates any of the cached rules to determine whether the object should be supplied to the requesting end user device, and further whether the data object should be cached on cache node 405.

In some implementations, the purge message received by cache node 405 may include a TTL identifying the amount of time that the included purge rule is valid. Accordingly, rule 423 that is cached as part of the operations of cache node 405 would only be valid for as long as the TTL. Once the TTL expires, rule 423 may be deleted permitting data objects that would otherwise be rejected by rule 423 to be cached and/or provided to requesting end user devices.

In some examples, to generate the purge messages, a user at a management console or some other management device may define a purge rule as a function with a metadata identifier and a value, which together form a content attribute pair. For example, if a user desired to purge all content associated with an author named “Johnson,” then a purge function may be specified as follows, PURGE(AUTHOR, JOHNSON), wherein author is the metadata identifier or attribute identifier and Johnson is the value associated with the attribute identifier. Further, multiple content attribute pairs may be applied within a single function, such as an author name and a text content written by the author. This function may appear as follows, PURGE(AUTHOR, JOHNSON; TEXT, TEXTCONTENT). Once the functions are generated, they may be transferred as rules within purge messages to be applied by the cache nodes of the content delivery network. In particular, the cache nodes would identify any data object cached on the cache nodes that are associated with the attributes of the purge message. Further, in some examples, when the cache node caches data objects for multiple tenants or multiple organizations, the cache node may only purge objects associated with the particular tenant making the purge request.

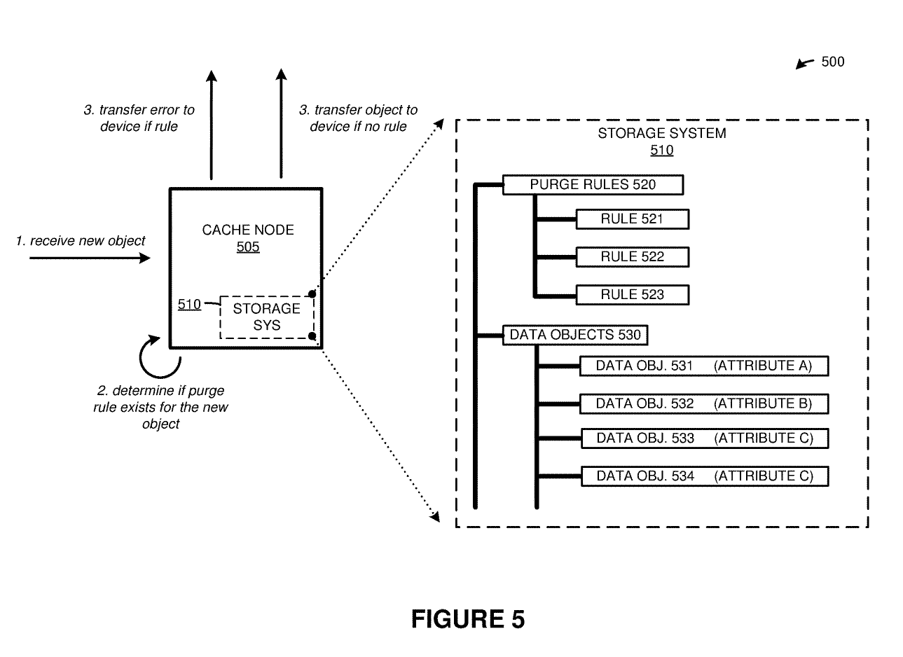

FIG. 5 illustrates an operational scenario 500 of providing a data object to an end user device according to one implementation. Operational scenario 500 includes cache node 505 with storage system 510. Storage system 510 includes storage mediums and controller capable of caching purge rules 520 with rules 521-523 and data objects 530 with data objects 531-534. Cache node 505 is representative of a cache node similar to CNs 120-121 in FIG. 1.

In operation, cache node 505 receives, at step 1, a new object from a second node, wherein the second node may comprise an origin server or a second cache node of the content delivery network. In some implementations, prior to receiving the new data object, cache node 505 may receive a content request from an end user device. Responsive to the request, cache node 505 would determine if an object were available in storage system 510 and data objects 530 to support the request. If the object were available to cache node 505, then cache node 505 may provide the data object to the end user device. However, if the object were not available, as depicted in FIG. 5, cache node 505 may request the object from a second node.

Once the object is received from the second node, cache node 505 determines, at step 2, if a purge rule exists for the data object. Specifically, cache node 505 may check purge rules 520 that are cached on the node to determine if a purge rule exists for the received data object. Once checked, at step 3, cache node may provide the received data object to the end user device or may transfer an error or no data to the end user device if a rule exists for the received data object. In some implementations, when a rule does not exist for the received data object, cache node 505 may further cache the received data object in data objects 530. This permits future requests to cache node 505 to be handled without a request to a second node.

While demonstrated in the example of FIG. 5 as receiving a data object from a second node, it should be understood that other information may be provided from the second node. For example, in response to a request for a data object, the second node may determine that the data object had previously been purged from the second node. Consequently, the second node may provide a notification to cache node 505 that the object had been purged. Based on the notification, cache node 505 may respond to the end user request, wherein the response may include an error message for the object, no response for the object, or may include the object, but may prevent the object from being cached locally on cache node 505.

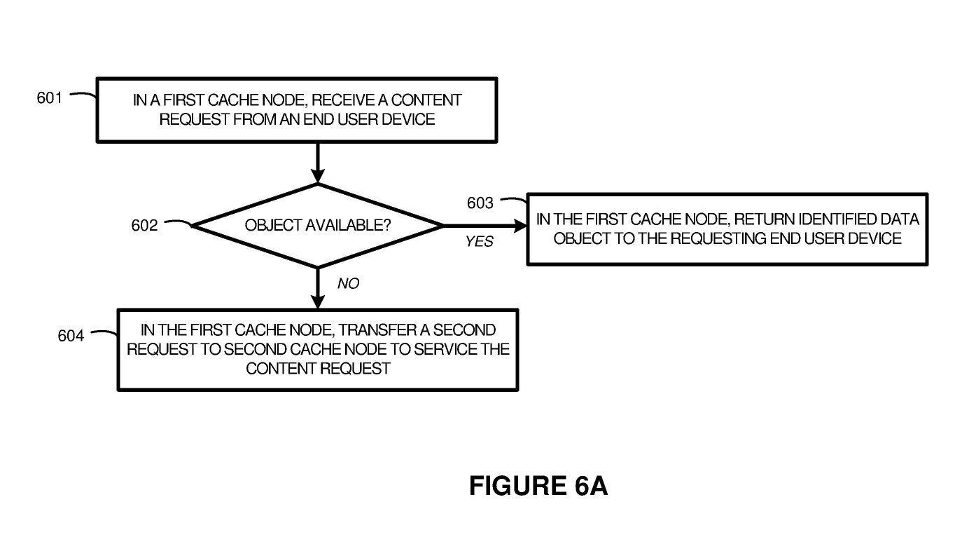

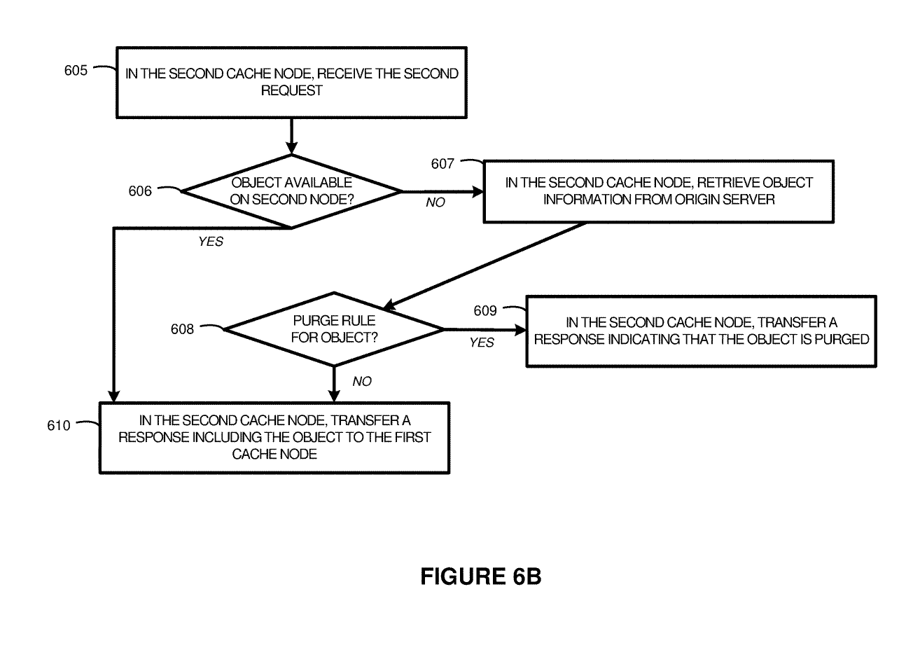

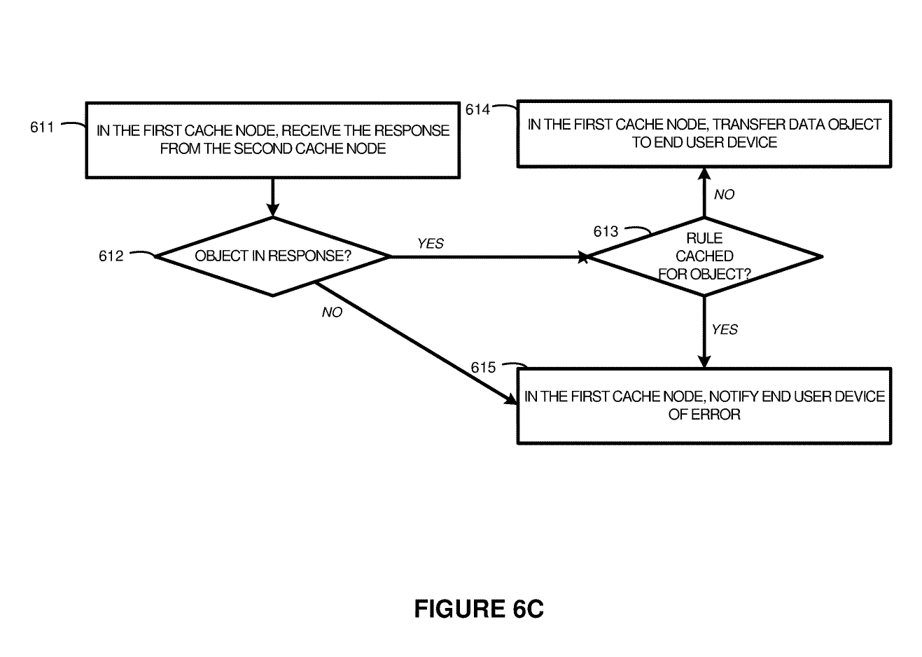

FIGS. 6A-6C illustrate a method of operating a content delivery network to respond to an end user device request according to one implementation. The operations of FIG. 2 are referenced parenthetically in the paragraphs that follow, along with references to the elements and systems from communication system 100 of FIG. 1. In particular, the first cache node described below will be described with references to CN 120, and the second cache node described below will be described with references to CN 121.

Beginning with FIG. 6A, a first cache node receives a content request from an end user device (601). In response to the request, the first cache node determines if an object is available to service the request (602). If an object is available on the first node to service the request, the first cache node will return the identified data object to the requesting end user device (603). In contrast, if an object is not available to service the request, the first cache node transfers a second request to a second cache node to service the content request (604).

Referring now to FIG. 6B, the second cache node receives the second request from the first cache node (605), and determines if there is an object available to service the request (606). If the second cache node identifies an object is available to service the request, the second cache node transfers a response to the first cache node including the identified data object (610). However, if an object is not available to service the request, the second cache node retrieves the object from an origin server (607), and determines if a purge rule exists on the second cache node for the retrieved object (608). If a purge rule does exist for the retrieved data object, the second cache node transfers a response to the first cache node indicating that the data object has been purged (609). In contrast, if a purge rule does not exist for the retrieved data object, the second cache node transfers a response to the first cache node including the retrieved data object (610).

In some implementations, when it is identified that the object has been purged, the second cache node may be configured to provide an indication of the purge to the first cache and may also provide the identified data object. However, it should be understood that when a purge is detected by the second node, no data object may be provided to the first node. Further, in some implementations, rather than requesting the data object from an origin server, it should be understood that the second node may query a third cache node node of the content delivery network.

Referring now to FIG. 6C and operations of the first cache node, the first cache node receives the response from the second cache node (611) and determines if a valid object is included in the response (612), wherein a valid object response indicates that the object has not been purged. If a valid data object is not included in the response from the second cache node, the first cache node transfers a notification to the end user device indicating an error in retrieving the object (615). This notification may include an express notification that the object is unavailable or may include a response without the object.

Alternatively, if a valid data object is included in the response from the second cache node, the first cache node determines if there is a purge rule for the received data object (613). If a purge rule exists for the received data object, the first cache node transfers a notification to the end user device indicating an error in retrieving the object (615), wherein the notification may include an express notification that the object is unavailable or may include a response without the object. However, if a rule does not exist for the received object, the first cache node can transfer the data object to the end user device (614).

Although described above with the interaction of two cache nodes of a content delivery network, it should be understood that the first cache node may request content and/or purging information from an origin server associated with the content.

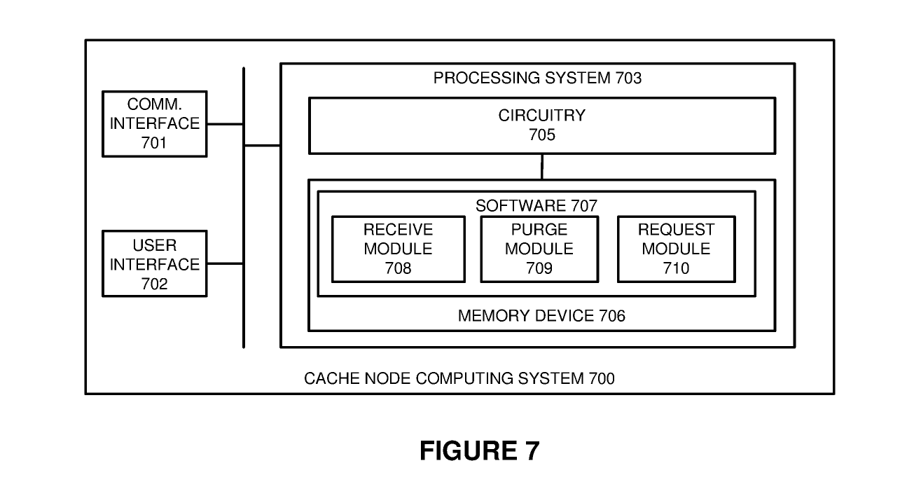

FIG. 7 illustrates a cache node computing system 700 to distribute origin requests to multiple origin servers according to one implementation. Cache node computing system 700 is representative of any computing system or systems with which the various operational architectures, processes, scenarios, and sequences disclosed herein for a cache node may be implemented. Cache node computing system 700 is an example of cache nodes 120-121 from FIG. 1, cache node 405 from FIG. 4, and cache node 505 from FIG. 5, although other examples may exist. Cache node computing system 700 comprises communication interface 701, user interface 702, and processing system 703. Processing system 703 is linked to communication interface 701 and user interface 702. Processing system 703 includes processing circuitry 705 and memory device 706 that stores operating software 707. Cache node computing system 700 may include other well-known components such as a battery and enclosure that are not shown for clarity. Cache node computing system 700 may comprise one or more server computing systems, desktop computing systems, laptop computing systems, or any other computing system, including combinations thereof.

Communication interface 701 comprises components that communicate over communication links, such as network cards, ports, radio frequency (RF), processing circuitry and software, or some other communication devices. Communication interface 701 may be configured to communicate over metallic, wireless, or optical links. Communication interface 701 may be configured to use Time Division Multiplex (TDM), Internet Protocol (IP), Ethernet, optical networking, wireless protocols, communication signaling, or some other communication format—including combinations thereof. In particular, communication interface 701 is configured to communicate with origin servers to cache content to be provided to end user devices.

User interface 702 comprises components that interact with a user to receive user inputs and to present media and/or information. User interface 702 may include a speaker, microphone, buttons, lights, display screen, touch screen, touch pad, scroll wheel, communication port, or some other user input/output apparatus—including combinations thereof. User interface 702 may be omitted in some examples.

Processing circuitry 705 comprises microprocessor and other circuitry that retrieves and executes operating software 707 from memory device 706. Memory device 706 comprises a non-transitory storage medium, such as a disk drive, flash drive, data storage circuitry, or some other memory apparatus. Processing circuitry 705 is typically mounted on a circuit board that may also hold memory device 706 and portions of communication interface 701 and user interface 702. Operating software 707 comprises computer programs, firmware, or some other form of machine-readable processing instructions. Operating software 707 includes receive module 708, purge module 709, and request module 710, although any number of software modules may provide the same operation. Operating software 707 may further include an operating system, utilities, drivers, network interfaces, applications, or some other type of software. When executed by processing circuitry 705, operating software 707 directs processing system 703 to operate cache node computing system 700 as described herein.

In at least one implementation, receive module 708 directs processing system 703 to receive purge messages, via communication interface 701, to purge content cached by cache node computing system 700. In response to receiving a purge message, purge module 709 directs processing system 703 to identify data objects to be purged on cache node computing system 700 based on a purge rule included in the purge message, wherein the purge rule comprises at least one content attribute related to the content in the identified data object. The content attributes that define the data objects to be purged may comprise author information for the data objects, text content information for the data objects, title information for the data objects, or any other similar information related to the content of the data object. For example, an administrator of a content delivery network may initiate a purge to erase or make inaccessible all data objects associated with particular textual content that were written by a specific author. Thus, cache node computing system 700 would identify the data objects by the author with the text content. Once the items are identified based on the content attributes, purge module 709 directs processing system 703 to purge the identified data objects.

In some implementations, in addition to purging data objects based on the purge rules identified in the purge messages, purge module 709 may further direct processing system 703 to cache the received purge rules. This caching of the purge rules prevents future data objects retrieved by cache node computing system 700 from being cached and or delivered to a requesting end user device. Referring again to the example with the author name and textual content, cache node computing system 700 may prevent future data objects with the author name and textual content, received from secondary nodes, from being cached on cache node computing system 700. Further, in some examples, the purge messages may also include TTLs for each of the purge rules included therein. These TTLs indicate time for which each of the purge rules are valid. Thus, once the TTL has expired for a particular purge rule, cache node computing system 700 may delete the purge rule, permitting content that would otherwise be blocked by the purge rule to be cached in the storage system of the cache node. While demonstrated in the previous example as including the TTL within the purge message, it should be understood that in some implementations the TTL may be configured locally on cache node computing system 700. Thus, as purge rules are received, computing system 700 may apply the TTL configuration to define a TTL for each of the purge rules.

As data objects are purged and purge rules are cached on cache node computing system 700, end user devices may generate content requests that are received at cache node computing system using communication interface 701. Request module 710 directs processing system 703 to receive the requests, and determine if a data object is cached on the cache node to service the request. If an object is available, request module 710 directs processing system 703 to provide the available data object. However, if a data object is not available for the request, request module 710 directs processing system 703 to transfer a second request, via communication interface 701, to a second node for the data object, wherein the second node may comprise a second cache node or an origin server. Once the request is transferred, a response is received from the second cache node using communication interface 701, and request module 710 directs processing system 703 to handle the response to the end user request based on the received response. In particular, if a purge indication is received in the response, then no data object will be provided to the end user device and, in some implementations, no data object will be cached by cache node computing system 700. Further, in examples where a purge indication is received, the purge indication may include the required purge rule for caching by cache node computing system 700.

In other implementations, where a purge indication is not received in the response from the second node, but a valid data object is received, request module 710 directs processing system 703 to determine if a purge rule local to cache node computing system 700 applied to the received data object. If no rule applies, then the object is provided to the requesting end user device and, in some examples, cached by computing system 700. However, if a rule does apply, then the object may be prevented from being provided to the end user device and the data object may be prevented from being cached by computing system 700.

In some examples, rather than providing a data object when found on cache node computing system 700, cache node computing system 700 may transfer a request to a second node to determine if a purge rule exists for the object, but has not yet been received by computing system 700. If the second node informs computing system 700 that no rule exists, then the identified data object may be provided to the end user device. However, if the second node provides a purge rule for the data object, then the object may be purged from computing system 700 and prevented from being supplied to the end user device.

Returning to the elements of FIG. 1, CNs 120-121 and origin servers 111-112 can each include communication interfaces, network interfaces, processing systems, computer systems, microprocessors, storage systems, storage media, or some other processing devices or software systems, and can be distributed among multiple devices. Examples of CNs 120-121 and origin servers 111-112 can include software such as an operating system, logs, databases, utilities, drivers, caching software, networking software, and other software stored on a computer-readable medium. CNs 120-121 and origin servers 111-112 may each comprise, in some examples, one or more server computing systems, desktop computing systems, laptop computing systems, or any other computing system, including combinations thereof.

End user devices 130-131 can each be a user device, subscriber equipment, customer equipment, access terminal, smartphone, personal digital assistant (PDA), computer, tablet computing device, e-book, Internet appliance, media player, game console, or some other user communication apparatus, including combinations thereof. End user devices 130-131 can each include communication interfaces, network interfaces, processing systems, computer systems, microprocessors, storage systems, storage media, or some other processing devices or software systems.

Communication links 170-172 each use metal, glass, optical, air, space, or some other material as the transport media. Communication links 170-172 can each use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication links 170-172 can each be a direct link or can include intermediate networks, systems, or devices, and can include a logical network link transported over multiple physical links. Although one main link for each of links 170-176 is shown in FIG. 1, it should be understood that links 170-172 are merely illustrative to show communication modes or access pathways. In other examples, further links can be shown, with portions of the further links shared and used for different communication sessions or different content types, among other configurations. Communication links 170-172 can each include many different signals sharing the same associated link, as represented by the associated lines in FIG. 1, comprising resource blocks, access channels, paging channels, notification channels, forward links, reverse links, user communications, communication sessions, overhead communications, carrier frequencies, other channels, timeslots, spreading codes, transportation ports, logical transportation links, network sockets, packets, or communication directions.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of operating a cache node in a content delivery network, the method comprising:
caching data objects in the cache node on behalf of at least one origin server;
receiving a set of purge messages, wherein each purge message in the set of purge messages comprises a rule that specifies at least one content attribute to be purged from the cache node;
applying the rule to the data objects to identify which subset of the data objects have the content attribute specified in the rule; and
purging the subset of the data objects from the cache node.

2. The method of claim 1 wherein the at least one content attribute comprises at least one of text content, title information, author information, or subject information for the subset of the data objects.

3. The method of claim 1 further comprising caching the rules for the set of purge messages.

4. The method of claim 3 further comprising:
receiving a new data object from a second node;
identifying whether the new data object is purged based on the cached rules;
if the new data object is purged, preventing the data object from being cached in the cache node.

5. The method of claim 4 further comprising receiving a first object request from an end user device, and transferring a second object request to the second node based on the first object request, wherein receiving the new data object from the second node comprises receiving the new data object from the second node in response to the second object request.

6. The method of claim 5 wherein transferring the second object request to the second node based on the first object request comprises identifying that no data object cached in the cache node services the first object request and, in response to identifying that no data object cached in the cache node services the first object request, transferring the second object request to the second node to service the first object request.

7. The method of claim 5 further comprising, if the new data object is not purged, transferring the data object to the end user device.

8. The method of claim 5 further comprising, if the new data object is purged, providing an error message to the end user device.

9. The method of claim 5 wherein the second node comprises one of an origin server or a second cache node of the cache nodes.

10. The method of claim 3 further comprising:
receiving a first object request from an end user device;
identifying that no data object cached in the cache node services the first object request;
in response to identifying that no data object can service the first object request, transferring a second object request to a second node to service the first object request;
receiving an indication from the second node that an object to service the first object request has been purged; and
transferring an error notification to the end user device based on the indication.

11. The method of claim 3 wherein each purge message in the set of purge messages further comprises time to live information indicative of an amount of time that each rule is valid.

12. A computing apparatus comprising:
one or more computer readable storage media;
a processing system operatively coupled with the one or more computer readable storage media;
program instructions stored on the one or more computer readable storage media to operate a cache node of a content delivery network that, when read and executed by the processing system, direct the processing system to at least:
cache data objects in the cache node on behalf of at least one origin server;
receive a set of purge messages, wherein each purge message in the set of purge messages comprises a rule that specifies at least one content attribute to be purged from the cache node;
apply the rule to the data objects to identify which subset of the data objects have the content attribute specified in the rule; and
purge the subset of the data objects from the cache node.

13. The computing apparatus of claim 12 wherein the at least one content attribute comprises at least one of text content, title information, author information, or subject information for the subset of the data objects.

14. The computing apparatus of claim 12 wherein the program instructions further direct the processing system to cache the rules for the set of purge messages.

15. The computing apparatus of claim 14 wherein the program instructions further direct the processing system to:
receive a new data object from a second node;
identify whether the new data object is purged based on the cached rules; and
if the new data object is purged, prevent the data object from being cached in the cache node.

16. The computing apparatus of claim 15 wherein the program instructions further direct the processing system to:
receive a first object request from an end user device;
identify that no data object cached on the cache node services the first object request; and
transfer a second object request to the second node for a data object to service the first object request, and
wherein the program instructions to receive the new data object from the second node direct the processing system to receive the new data object from the second node in response to the second object request.

17. The computing apparatus of claim 16 wherein the program instructions further direct the processing system to, if the new data object is not purged, transfer the data object to the end user device.

18. The computing apparatus of claim 16 wherein the program instructions further direct the processing system to, if the new data object is purged, provide an error message to the end user device.

19. The computing apparatus of claim 16 wherein the second node comprises one of an origin server or a second cache node in the content delivery network.

20. The computing apparatus of claim 14 wherein the program instructions further direct the processing system to:
receive a first object request from an end user device;
identify that no data object cached in the cache node services the first object request;
in response to identifying that no data object can service the first object request, transfer a second object request to a second node to service the first object request;
receive an indication from the second node that an object to service the first object request has been purged; and
transfer an error notification to the end user device based on the indication.
